(19) United States
(12) Patent Application Publication
(10) Pub. No.: US 2018/0026281 A1
(43) Pub. Date: Jan. 25, 2018

(54) KNOCK-OUT VALVE WITH AN EXTENSION TUBE FOR FUEL CELL PURGING

(71) Applicant: Ford Global Technologies, LLC, Dearborn, MI (US)

(72) Inventor: Seha SON, Ann Arbor, MI (US)

(21) Appl. No.: 15/217,161

(22) Filed: Jul. 22, 2016

(51) Int. Cl. H01M 8/04223; H01M 8/04089; H01M 8/04119

(52) U.S. Cl. CPC H01M 8/04253; H01M 8/04223; H01M 8/04179; H01M 8/04097; H01M 8/04231; H01M 2250/20

(57) ABSTRACT

A knock-out assembly for a fuel cell purge line includes a separator, a valve and a tube. The separator has a drain fluidly coupled to a body attached to an anode. The valve has a first inlet attached to and in fluid communication with the drain. The tube is disposed within the drain and the first inlet, and is configured to extend into the body and away from the drain.

### TECHNICAL FIELD

The present disclosure relates to knock-out valves for fuel cell stacks for vehicles.

### BACKGROUND

During fuel cell operation, byproducts such as product water and nitrogen, as well as unconsumed hydrogen, may form at the anode side of a fuel cell stack. In certain known systems, accumulation of product water and nitrogen accumulation is controlled in an attempt to avoid a reduction in fuel cell performance, and/or fuel cell system shut down. One known approach is to release the water and nitrogen via a passageway downstream of the fuel cell stack. Using such approach, the passageway is coupled with a valve for the controllable release of water and nitrogen from the fuel cell stack. This approach causes the potential for problems to occur during cold weather operation of the fuel cell when water may freeze in the passageway, or valve, or other regions of the fuel cell with small cross sectional areas. The resulting ice formation may cause blockage of at least a portion of the passageway and prevent fluid flow (e.g., water and nitrogen removal), which may inhibit fuel cell system function.

### SUMMARY

A knock-out assembly for a fuel cell purge line includes a separator, a valve and a tube. The separator has a drain fluidly coupled to a body attached to an anode. The valve has a first inlet attached to and in fluid communication with the drain. The tube is disposed within the drain and the first inlet, and is configured to extend into the body and away from the drain.

A fuel cell system includes a fuel cell stack and a knock-out assembly in fluid communication with the fuel cell stack. The fuel cell stack includes a separator having a body and first and second drains fluidly coupled to first and second inlets of a valve, respectively, wherein the first inlet and drain includes a tube disposed therein and configured to extend into the body and away from the first drain.

A knock-out assembly for a fuel cell purge line includes a separator, a first valve, a second valve and a tube. The separator has first and second drains fluidly coupled to a body attached to an anode. The first valve has a first inlet attached to and in fluid communication with the first drain. The second valve has a second inlet attached to and in fluid communication with the second drain. The tube extends between the drain and the first inlet such that, upon blockage of the third inlet, the tube defines a fluid passageway from the body through the drain into the first valve.

### BRIEF DESCRIPTION OF THE DRAWINGS

FIG. 1 is a perspective view of a vehicle having a fuel cell system on an inclined surface;

FIG. 2 is a side view of a knock-out assembly for a purge line assembly for a vehicle fuel cell system with respect to the horizontal axis;

FIG. 3 is a cross-sectional view of a knock-out drain interconnected to a valve inlet using a tube supported by a plurality of supports;

FIG. 4 is a side view of a knock-out assembly for a purge line assembly for a vehicle fuel cell system according to a further embodiment; and

FIG. 5 is a side view of a knock-out assembly for a purge line assembly for a vehicle fuel cell system.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

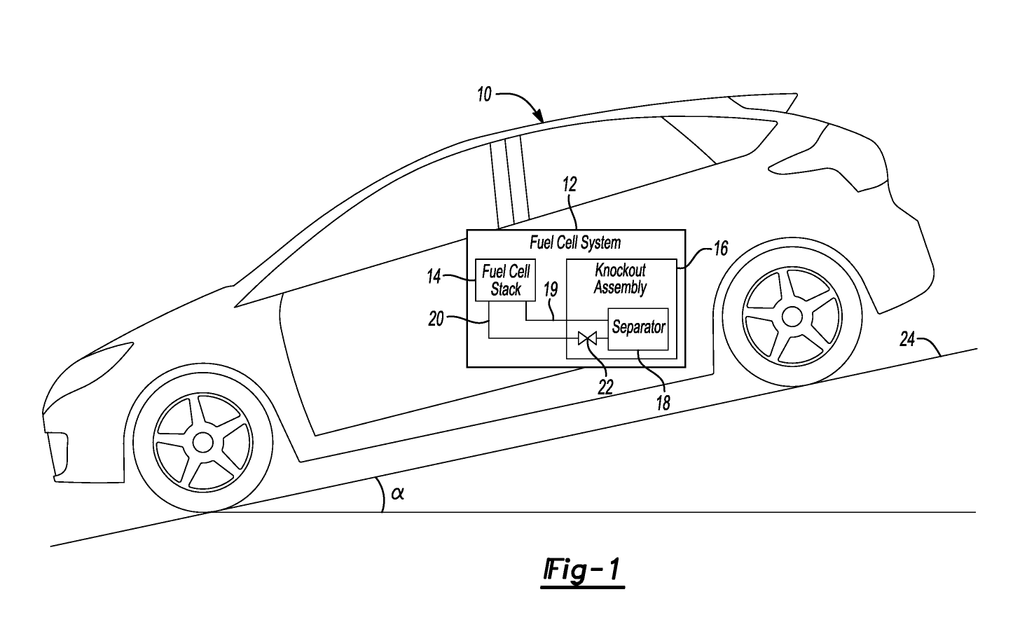

Referring to FIG. 1, a vehicle 10 having a fuel cell system 12 is generally shown. The fuel cell system 12 may include a fuel cell stack 14 and a knock-out assembly 16. The knock-out assembly includes a separator 18 downstream of and in fluid communication with the fuel cell stack 14 via a passageway 20, and a valve 22. As will be described in more detail below, the valve 22 is positioned downstream and attached to the separator 18. During fuel cell system operation, product water, nitrogen, and residual hydrogen may flow from the fuel cell stack 14 into the separator 18 via the passage 20. In the separator 18, the product water is separated from the residual hydrogen and nitrogen. The product water exits the separator 18 through passage 20. In certain instances, the separated hydrogen may be returned back to the fuel cell stack 14 via a hydrogen return passageway 19.

To ensure efficient fuel cell system operation, the product water may be purged from the separator 18 via the valve 22. During cold weather operation, the product water may freeze in the separator 18 causing blockage of the valve 22 and preventing purging of the fuel cell system 12. Specifically, cold weather operation or freezing conditions may include subjecting the fuel cell system 12 to temperatures below the freezing point of product water, nitrogen, and residual hydrogen. Cold weather operation or freezing conditions may also include subjecting the fuel cell system 12 to temperatures below the freezing points of any other potential byproduct that gathers in the separator 18. For example, when described herein, cold weather operation and freezing conditions may include operation of the fuel cell system 12 in temperatures equal to or less than 32° F., 0° C. or 273° K.

Likewise, the vehicle 10 may operate on a variety of roadways 24 having a variety of pitch angles α. For example, the vehicle 10 may be on a roadway 24 having a pitch of ±19.5 degrees. Therefore, the fuel cell system 12 may also be disposed at the pitch angle α of the roadway 24 based on a position of the vehicle 10. When the fuel cell system 12 is disposed at the pitch angle α of the roadway 24 during freezing conditions, the knockout assembly 16 may be configured to account for blockage through the separator 18 into the valve 22 due to freezing product water. The knockout assembly 16, and specifically the separator 18 and valve 22 may be configured in a way such that the knockout assembly 16 can purge water and nitrogen from the fuel cell stack 14 accounting for an increase in depth of the product water due to the pitch angle α of the roadway 24.

Typically, the fuel cell system 12 in the knockout assembly 16 may use a scavenging reservoir (not shown) to account for the product water and the blockage between the separator 18 and the valve 22 during freezing conditions and an inclined pitch angle α that may occur due to accumulation of the product water. However, the scavenging reservoir may only account for a set volume of product water and accumulation of product water may result in complete blockage. Likewise, the scavenging reservoir may not completely account for the pitch angle α of the roadway 24, which may also lead to complete blockage. Lastly, the scavenging reservoir may not effectively purge the fuel cell system 12 due to the position and inherent nature of the reservoir within the fuel cell system 12 resulting in an accumulation of product water and therefore complete blockage of the fuel cell system. Therefore, a knockout assembly 16 that accounts for the pitch angle α of the roadway 24 and the freezing conditions described above that eliminates a scavenging reservoir may be advantageous.

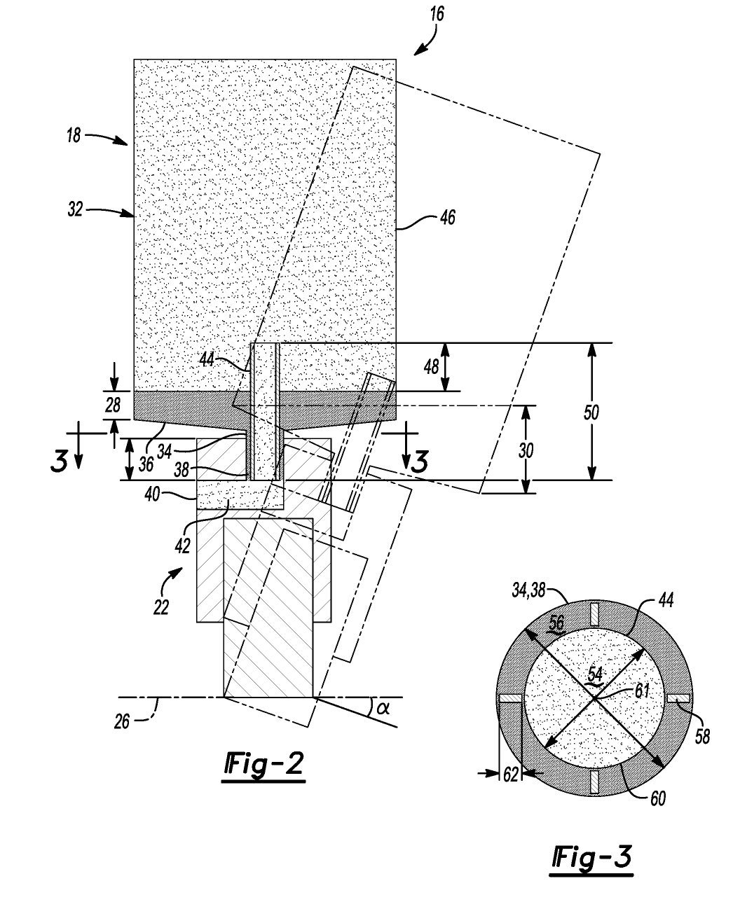

FIG. 2 depicts a side view of the knockout assembly 16 showing connection between the separator 18 and the valve 22 in both horizontal and tilted positions. The tilted position, shown in phantom, shows the knockout assembly 16 tilted with respect to a horizontal axis 26 indicative of the pitch angle α of the roadway 24. Again, the pitch angle α may be approximately 19.5°. At least one other embodiment, the pitch angle α of the roadway 24 may be within a range of angles from about 10 to 45°. When the knockout assembly 16 is tilted at the pitch angle α, the product water may move with the knockout assembly 16 and change depth. As will be described in more detail below, the product water may collect within the knockout assembly 16 at a first depth 28 when the knockout assembly is substantially level and at a second depth 30 when the knockout assembly is tilted at the pitch angle α.

The separator 18 defines a body 32 and a drain 34. The body 32 is fluidly connected to the drain 34. Specifically, the drain 34 is disposed at a bottom 36 of the body 32. The drain 34 may also be referred to as a first drain 34. The product water collects within the body 32 of the separator 18 and may create blockage of the drain 34 during freezing conditions. The valve 22 is fluidly coupled to the separator 18. Specifically, the valve 22 includes an inlet 38 that fluidly couples the valve 22 to the bottom 36 of the body 32 through the drain 34. The valve 22 may also include an outlet 40. When the valve 22 is in a closed position, there is no fluid flow between the separator 18, including the body 32 and the drain 34 and the valve 22 through the inlet 38 or the outlet 40. When the valve 22 is in an open position, as shown, fluid passage is defined between the outlet 40 and the inlet 38 of the valve 22, and the drain 34 and body 32 of the separator 18. Specifically, in order for the knockout assembly 16 to be effectively purged, coupling between the drain 34 and the inlet 38 should be open such that fluid flow from the body 32 of the separator 18 through the outlet 40 of the valve 22 is uninterrupted.

When the fuel cell system 12, and specifically the knockout assembly 16 is subject to conditions that may cause the product water to freeze, coupling between the inlet 38 of the valve 22 and the drain 34 of the separator 18 may be blocked. Blockage between the inlet 38 of the valve 22 and the drain 34 of the separator 18 results in an interrupted or stopped fluid passage between the outlet 40 of the valve 22 and the body 32 of the separator 18. Interrupted or stopped fluid passage between the outlet 40 of the valve 22 and the body 32 of the separator 18 causes purging failure of the fuel cell system 12 and specifically the knockout assembly 16. Moreover, sustained blockage of the drain 34 of the separator 18 and the inlet 38 of the valve 22 from ineffectual purging of the knockout assembly 16 may result in inefficiencies of the fuel cell system 12, making the fuel cell system 12 ineffective. Therefore, the knockout assembly 16, and specifically the coupling between the inlet 38 of the valve 22 and the drain 34 of the separator 18 may be configured to create a passageway 42 through the inlet 38 of the valve and the drain 34 of the separator 18 that extends above the first depth 28 and the second depth 30, as described above.

The knockout assembly 16 may further include a tube 44. The tube 44 may be an extension tube 44, which extends between the inlet 38 of the valve 22 and the drain 34 of the separator 18. The tube 44 may be configured to extend away from the drain 34 of the separator 18 and into the body 32 of the separator 18. The tube 44 may extend into the body 32 of the separator such that the tube 44 extends above the first depth 28 and the second that 30 to create the passageway 42 that fluidly couples the separator 18 and the valve 22. The passageway 42 is therefore defined through the tube 44 and interconnects the body 32 of the separator 18 and the outlet 40 of the valve 22. The tube 44 may be composed of a relatively insulative material such that heat transfer through the tube 44 during cold weather operation of the knockout assembly 16 does not result in a significant temperature difference inside the tube 44, preventing condensation formation within the tube 44. Therefore, when the valve 22 is open, the tube 44 allows the passageway 42 to be clear and unobstructed for purging.

As can be seen with reference to FIG. 2, the tube 44 creates the passageway 42 despite the knockout assembly 16 being tilted at the pitch angle α resulting in the greater second depth 30 described above. When tilted, the product water may accumulate on either side 46 of the body 32 of the separator 18. The tube 44 accounts for this accumulation by extending away from the drain 34 and into the body 32 at a height 48 above the first depth 28, wherein the first depth 28 may be defined from an expected volume of accumulated product water due to repeated purging cycles of the knockout assembly 16. When the knockout assembly 16 is tilted based on the pitch angle α of the roadway 24 with respect to the horizontal axis 26, the tube 44 extends above the second depth 30, wherein the second depth 30 may be calculated from the expected volume defining the first depth 28 and the range of pitch angles α described above. Therefore, the tube 44 may define a total length 50 based on the calculated second depth 30 from the pitch angle α and the first depth 28 that defines the height 48 the tube 44 extends into the body 32 and a distance 52 defined from coupling of the drain 34 and inlet 38. Stated differently, the distance 52 defined from coupling the drain 34 and the inlet 38 in addition to the height 48 define the total length 50 of the tube 44.

The tube 44 therefore extends between and interconnects the drain 34 of the separator 18 and the inlet 38 of the valve 22. The tube 44 provides further coupling between the separator 18 and the valve 22 of the knockout assembly 16. By providing additional coupling between the body 32 of the separator 18 and the outlet 40 of the valve 22 specifically, the tube 44 allows the passageway 42 to be an additional passageway to promote purging during normal operational use of the fuel cell system 12. The tube 44 also allows the fuel cell system 12 to purge the knockout assembly 16 without requiring a scavenging reservoir (not shown), as discussed above. Stated differently, the tube 44 replaces the scavenging reservoir and allows the knockout assembly 16 to account for a greater volume of product water based on the significantly larger body 32 of the separator 18 compared to a scavenging reservoir. Therefore, the tube 44 reduces the complexity of the knockout assembly 16 and increases the efficiency of the fuel cell system 12.

FIG. 3 depicts a cross-sectional view of the tube 44 extending between the drain 34 and the inlet 38 along the lines 2-2 shown in FIG. 2. As shown in FIG. 3, the tube 44 and the drain 34 and inlet 38 may be concentric. In at least one other embodiment, the tube 44 may be off-set from the drain 34 and inlet 38. For example, the tube 44 may be welded within the drain 34 and inlet 38 such that the tube 44 is tangent to the drain 34 and inlet 38. In this embodiment, the tube 44 may be made flush at the welded areas (not shown) for closing both openings during operation of the valve 22. Further, the tube 44 may have a diameter 54 less than a diameter 56 of the drain 34 and inlet 38. The concentricity and the differing diameters allow the tube 44 to define the passageway 42 through the separator 18 and into the valve 22. For example, the passageway 42 may be defined by the diameter 54 of the tube 44.

The diameter 54 of the tube 44 may be based on the purging requirements of the knockout assembly 16. Likewise, the diameter 54 of the tube 44 may be less than the diameter 56 of the drain 34 to account for blockage between the drain 34 and the inlet 38 when the fuel cell system 12 is operated under freezing conditions. Further, the difference between the diameter 54 of the tube 44 and the diameter 56 of the drain 34 allows product water to be purged through the knockout assembly 16 when the fuel cell system 12 is operated in non-freezing conditions. Using the tube 44 having a diameter 54 less than the diameter 56 of the drain 34 and inlet 38 allows the knockout assembly 16 to maintain a consistent purging cycle under freezing conditions as well as purge the product water under non-freezing conditions. Again, the tube 44, via the smaller diameter 54, defines an additional passageway 42 between the body 32 of the separator 18 and the outlet 40 of the valve 22 to allow purging of the knockout assembly 16 during all operating conditions. The diameter 54 of the tube may be between 4 mm and 25 mm. Further, in at least one other embodiment, the passageway 42 defined between the tube 44 and the drain 34 and inlet 38 may be used solely for purging gaseous fluids.

Because the diameter 54 of the tube 44 is less than the diameter 56 of the drain 34 and the inlet 38, a plurality of supports 58 may be disposed between the tube 44 and the drain 34 and inlet 38. The supports 58 are configured to maintain the position of the tube 44 within the drain 34 and inlet 38. As depicted in FIG. 3, the plurality of supports 58 may include at least four supports 58. At least one other embodiment, the plurality of supports 58 may include two or more supports 58. Again, as depicted in FIG. 3, the each of the supports 58 is disposed at regular intervals around a perimeter 60 of the tube 44. For example, the supports 58 are placed every 90° around the perimeter 60 of the circular tube 44. In at least one other embodiment, the supports 58 may be placed every 180° around the perimeter 60 of the circular tube 44.

To effectively hold the tube 44 within the drain 34 and inlet 38, each of the supports 58 defines a length 62 equal to the difference between the diameter 54 of the tube 44 and the diameter 56 of the drain 34 and the inlet 38. By defining the length 62 of each of the supports 58 such that the length 62 is defined by the distance between the diameter 54 of the tube 44 and the diameter 56 of the drain 34 and the inlet 38, the supports 58 are in constant compression between the tube 44 and the drain 34 and inlet 38. Maintaining constant compression of the supports 58 allows the fuel cell system 12 to purge the knockout assembly 16 without displacing the tube 44. Therefore, the supports 58 prevent the tube 44 from collapsing into the valve 22. The supports 58 aid the tube 44 in maintaining the passageway 42 from the outlet 40 of the valve 22 and the body 32 of the separator 18.

The plurality of supports 58 may be configured to extend vertically with respect to a vertical axis 61 along the distance 52 between the coupling of the drain 34 and the inlet 38. The supports 58, therefore, extend with the tube 44 through the drain 34 and into the inlet 38. Extending the distance 52 allows the plurality of supports 58 to distribute compression between the tube 44 and the drain 34 and the inlet 38 throughout the distance 52. In at least one other embodiment, the plurality of supports 58 may be disposed within the drain 34 and the inlet 38 separately. For example, at least four supports 58 may maintain the position of the tube 44 within the drain 34 and at least four additional supports 58 disposed at a distance along the vertical axis 61 may maintain the position of the tube 44 within the inlet 38. Likewise, the plurality of supports 58 may extend the total length 50 of the tube 44.

In this embodiment, the supports 58 that extend into the body 32 of the separator 18 may define a length 62 greater than a length 62 of the supports 58 that extend into the drain 34 and the inlet 38. Each of the supports 58 extend the total length 50 of the tube 44 and each of the supports 58 may have a substantially tapered shape. Similarly, the supports 58 may be disposed vertically along the vertical axis 61 at regular intervals along the total length 50 of the tube 44. For example, at least four supports 58 may maintain the position of the tube 44 within the body 32, at least four additional supports 58 may maintain the position of the tube 44 within the drain 34 and at least four other supports 58 may maintain the position of the tube 44 within the inlet 38. The plurality of supports 58 may define any arrangement that allows the tube 44 to maintain a passageway 42 between the drain 34 and the inlet 38 to effectuate purging of the knockout assembly 16.

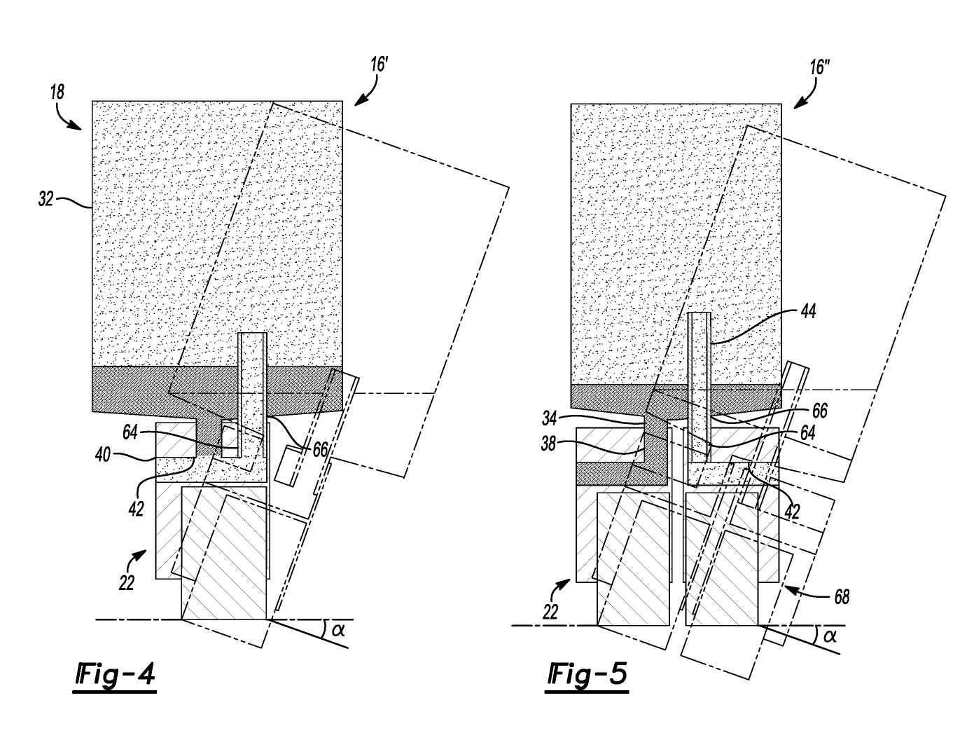

Referring to FIG. 4, a side view of a further embodiment of the knockout assembly 16′ is depicted. The embodiment depicted in FIG. 4 depicts the valve 22 having a second inlet 64 in addition to the inlet 38. Similarly, the embodiment depicted in FIG. 4 depicts the separator 18 having a second drain 66 in addition to the drain 34. In this embodiment, the tube 44 extends between the second inlet 64 and the second drain 66, wherein the second inlet 64 and the second drain 66 are parallel and adjacent to the inlet 38 and the drain 34. Therefore, when the inlet 38 and the drain 34 are blocked, the passageway 42 is defined by the tube 44 between the second inlet 64 and the second drain 66. As shown and described as having the tube 44 extend between the second inlet 64 and the second drain 66 to provide a fluid passageway 42 between the body 32 of the separator 18 and the outlet 40 of the valve 22, the tube 44 may, in at least one other embodiment, interconnect the drain 34 and the inlet 38 to create the fluid passageway 42 as described above.

In the embodiment depicted in FIG. 4, when the inlet 38 and the drain 34 are blocked, the tube 44 between the second inlet 64 and the second drain 66 allows purging through the passageway 42. Adding the second inlet 64 and the second drain 66 allows the knockout assembly 16′ to purge through the second inlet 64 and second drain 66 via the passageway 42 defined by the tube 44. For example, in cold weather conditions as detailed above, residual byproduct may freeze in the inlet 38 and the drain 34 and therefore by extending the tube 44 through the second inlet 64 and second drain 66, the knockout assembly 16′ maintains an open, fluid connection between the outlet 40 of the valve 22 and the body 32 of the separator 18. Again, by maintaining an open and fluid connection via the tube 44 within the second inlet 64 and the second drain 66, the knockout assembly 16′ maintains purging operations and effectiveness during all vehicle operational uses. Addition of the second drain 66 and second inlet 64 interconnected by the tube 44 to define a fluid passageway 42 between the outlet 40 of the valve 22 and the body 32 of the separator 18 provides further assurance that the knockout assembly 16′ may be effectively purged.

FIG. 5 depicts a side view of a further embodiment of the knockout assembly 16″. The embodiment depicted in FIG. 5 shows the drain 34 fluidly connected to the inlet 38 of the valve 22 and the second drain 66 fluidly connected to the second inlet 64 defined on a second valve 68. Using the valve 22 and the second valve 68 ensures that the knockout assembly 16″ maintains purging regardless of vehicle operation. For example, the tube 44 may extend through the second inlet 64 and second drain 66 to define the passageway 42 through the second valve 68. Therefore, if residual byproduct freezes within the body 32 of the separator 18 and occludes the drain 34 and the inlet 38 of the valve 22, purging of the knockout assembly 16″ may still be accomplished via the second valve 68 in a manner similar to the manner described previously. The second valve 68 may be adjacent to the first valve 22. Likewise, the second valve 68 may be substantially parallel to the first valve 22.

The second valve 68 may also be operational only if purging fails through the first valve 22. For example, the second valve 68 may be a normally closed valve and only be configured to open in the event purging fails through the first valve 22. For example, the second valve 68 may only be energized to provide a fluid passageway 42 between the second drain 66 and the second inlet 64 via the tube 44 if purging cannot be complete through the first valve 22. Again, addition of the second valve 68 ensures that the knockout assembly 16″ accomplishes purging regardless of vehicle use, as described above. In at least one other embodiment, the first valve 22 may be normally closed and include the tube 44 extending between the drain 34 and the inlet 38 to define a fluid passageway 42 between the body 32 of the separator 18 and the outlet 40 of the first valve 22 and only energize in the event that the second valve 68 is occluded or blocked causing the knockout assembly 16″ to fail to purge.

In each embodiment shown and described through FIGS. 2-5, the knockout assembly 16 defines at least two ways to effectively purge the knockout assembly 16. Specifically, each embodiment shown and described in FIGS. 2-5 utilize the tube 44 to interconnect the body 32 of the separator 18 and the outlet 40 of the valve 22 to provide open fluid communication via passageway 42 between the separator 18 and the valve 22 to facilitate purging of the knockout assembly 16. Further, each embodiment is configured to account for the road pitch angle α by extending the tube 44 into the body 32 of the separator 18, as described above. Therefore, while variation exists between each embodiment, each embodiment effectuates purging of the knockout assembly 16 during all vehicle uses including, but not limited to, cold weather conditions on an inclined roadway.

While exemplary to embodiments are described above, it is not intended that these embodiments describe all possible forms encompassed by the claims. The words used in the specification are words of description rather than limitation, and it is understood that various changes may be made without departing from the spirit and scope of the disclosure. As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and may be desirable for particular applications.

What is claimed is:

1. A knock-out assembly for a fuel cell purge line comprising:
a separator having a drain fluidly coupled to a body attached to an anode;
a valve having a first inlet attached to and in fluid communication with the drain; and
a tube disposed within the drain and the first inlet, and being configured to extend into the body and away from the drain.

2. The knock-out assembly of claim 1 further comprising a plurality of supports disposed around the tube being configured to secure the tube to the drain and inlet.

3. The knock-out assembly of claim 1, wherein the tube defines a circular cross-section such that a diameter of the tube is less than a diameter of the drain.

4. The knock-out assembly of claim 1, wherein the tube is concentric with the drain and the inlet.

5. The knock-out assembly of claim 1, wherein the valve further includes a second inlet disposed adjacent and parallel to the first inlet.

6. A fuel cell system comprising:
a fuel cell stack; and
a knock-out assembly in fluid communication with the fuel cell stack and including a separator having a body and first and second drains fluidly coupled to first and second inlets of a valve, respectively, wherein the first inlet and drain includes a tube disposed therein and configured to extend into the body and away from the first drain.

7. The fuel cell system of claim 6, wherein the first and second inlets are disposed in a parallel orientation.

8. The fuel cell system of claim 6, wherein the tube and the first inlet are concentric.

9. The fuel cell system of claim 6, wherein the valve is a normally closed valve.

10. The fuel cell system of claim 6, wherein the body defines a first threshold when the knock-out assembly is substantially level with respect to a horizontal axis of the knock-out assembly such that the tube extends beyond the first threshold.

11. The fuel cell system of claim 6, wherein the body defines a second threshold when the knock-out assembly is angled with respect to a horizontal axis of the knock-out assembly such that the tube extends beyond the second threshold.

12. The fuel cell system of claim 11, wherein the second threshold is defined with an angle within a range of 15 to 20 degrees.

13. A knock-out assembly for a fuel cell purge line comprising:
a separator having first and second drains fluidly coupled to a body attached to an anode;
a first valve having a first inlet attached to and in fluid communication with the first drain;
a second valve having a second inlet attached to and in fluid communication with the second drain; and
a tube extending between the drain and the first inlet such that, upon blockage of the second inlet, the tube defines a fluid passageway from the body through the drain into the first valve.

14. The knock-out assembly of claim 13, wherein the first valve is disposed adjacent the second valve.

15. The knock-out assembly of claim 13, wherein the tube is configured to extend into the body beyond a threshold volume level of the body.

16. The knock-out assembly of claim 15, wherein the threshold volume level defines a first threshold when the knock-out is substantially aligned with a horizontal axis of the knock-out.

17. The knock-out assembly of claim 15, wherein the threshold volume level defines a second threshold when the knock-out is angled with respect to a horizontal axis of the knock-out.

18. The knock-out assembly of claim 17, wherein the second threshold is defined by an angle within a range of 15 to 20 degrees.

19. The knock-out assembly of claim 13, wherein the tube is configured to insulate the first inlet from the drain.

20. The knock-out assembly of claim 13, wherein a diameter of the tube is less than a diameter of the first inlet such that the tube is secured within the inlet by a plurality of supports disposed at intervals around an outer periphery of the tube and extending a length of the fluid passageway.
